(19) United States
(12) Patent Application Publication
(10) Pub. No.: US 2025/0175922 A1
(43) Pub. Date: May 29, 2025

(54) METHOD FOR COMMUNICATION, AND TERMINAL DEVICE

(71) Applicant: GUANGDONG OPPO MOBILE TELECOMMUNICATIONS CORP., LTD., Dongguan (CN)

(72) Inventors: Xin YOU, Dongguan (CN); Xue LIN, Dongguan (CN); Jianfei CAO, Dongguan (CN)

(21) Appl. No.: 19/040,836

(22) Filed: Jan. 29, 2025

Related U.S. Application Data
(63) Continuation of application No. PCT/CN2022/120694, filed on Sep. 23, 2022.

(51) Int. Cl. H04W 56/00; H04W 72/231; H04W 74/0833; H04W 76/20

(52) U.S. Cl. CPC H04W 56/0045; H04W 72/231; H04W 74/0833; H04W 76/20

(57) ABSTRACT

Provided is a method for communication. The method is applicable to a terminal device, and the method includes: determining a type of a timing advance group (TAG) based on a first mode; and performing a first behavior based on the type of the TAG and a timer associated with the TAG.

### CROSS-REFERENCE TO RELATED APPLICATION

This application is a continuation of International Application No. PCT/CN2022/120694, filed Sep. 23, 2022, the entire disclosure of which is incorporated herein by reference.

### TECHNICAL FIELD

The present disclosure relates to the field of communication, and in particular, relates to a method for communication and a terminal device.

### RELATED ART

User equipment (UE) may be configured with a plurality of timing advance groups (TAGs) within one cell group (CG). A timing advance (TA) of the UE is updated and maintained based on the TAG. Typically, each serving cell is associated with one TAG. In some scenarios, each serving cell may be associated with a plurality of TAGs. In the case that one serving cell is associated with two primary timing advance groups (PTAGs), the operation of the UE following the timeout of the timers associated with the PTAGs may lead to service discontinuity.

### SUMMARY

Embodiments of the present disclosure provide a method for communication. The method is applicable to a terminal device and includes: determining a type of a timing advance group (TAG) based on a first mode; and performing a first behavior based on the type of the TAG and a timer associated with the TAG.

The embodiments of the present disclosure provide a terminal device. The terminal device includes a processor and a memory. The memory is configured to store one or more computer programs, and the processor is configured to load and run the one or more computer programs stored in the memory, to cause the terminal device to: determine a type of a timing advance group (TAG) based on a first mode; and perform a first behavior based on the type of the TAG and a timer associated with the TAG.

The embodiments of the present disclosure provide a chip. The chip is configured to perform the method for communication described above. Specifically, the chip includes a processor. The processor is configured to load and run one or more computer programs stored in a memory, to cause a device equipped with the chip to: determine a type of a timing advance group (TAG) based on a first mode; and perform a first behavior based on the type of the TAG and a timer associated with the TAG.

### BRIEF DESCRIPTION OF THE DRAWINGS

FIG. 1 is a schematic diagram of an application scenario according to some embodiments of the present disclosure;

FIG. 2 is a schematic diagram of a differential adjustment format for a TA;

FIG. 3 is a schematic diagram of an absolute value adjustment format for a TA;

FIG. 4 is a schematic diagram of a medium access control-control element (MAC) random access response (RAR);

FIG. 5 is a schematic diagram of an uplink and downlink scheduling scenario for multiple downlink control information-multi-transmission reception point (mDCI-mTRP);

FIG. 6 is a schematic flowchart of a method for communication according to some embodiments of the present disclosure;

FIG. 7 is a schematic block diagram of a terminal device according to some embodiments of the present disclosure;

FIG. 8 is a schematic block diagram of a communication device according to some embodiments of the present disclosure;

FIG. 9 is a schematic block diagram of a chip according to some embodiments of the present disclosure; and

FIG. 10 is a schematic block diagram of a communication system according to some embodiments of the present disclosure.

### DETAILED DESCRIPTION

The technical solutions according to the embodiments of the present disclosure are described hereinafter in conjunction with the accompanying drawings according to the embodiments of the present disclosure.

The technical solutions of the embodiments of the disclosure are applied to various communication systems, such as a global system of mobile communication (GSM) system, a code division multiple access (CDMA) system, a wideband code division multiple access (WCDMA) system, a general packet radio service (GPRS), a long-term Evolution (LTE) system, an advanced long-term evolution (LTE-A) system, a new radio (NR) system, an NR evolution system, an LTE-based access to unlicensed spectrum (LTE-U) system, an NR-based access to unlicensed spectrum (NR-U) system, a non-terrestrial networks (NTN) system, a universal mobile telecommunication system (UMTS), a wireless local area network (WLAN), a wireless fidelity (Wi-Fi) system, a 5th Generation (5G) system, or other communication systems.

Typically, traditional communication systems support a limited number of connections and are easy to implement. However, with development of communication technologies, mobile communication systems will support not only conventional communications, but also, for example, device-to-device (D2D) communications, machine-to-machine (M2M) communications, machine type communications (MTCs), vehicle-to-vehicle (V2V) communications, or vehicle-to-everything (V2X) communications. The embodiments of the present disclosure are also applicable to these communication systems.

In some embodiments, the communication systems in the embodiments of the present disclosure are applicable to a carrier aggregation (CA) scenario, a dual connectivity (DC) scenario, or a standalone (SA) networking scenario.

In some embodiments, the communication system according to the embodiments of the present disclosure is applicable to an unlicensed spectrum, wherein the unlicensed spectrum is considered as a shared spectrum; or the communication system according to the embodiments of the present disclosure is applicable to a licensed spectrum, wherein the licensed spectrum is considered as an unshared spectrum.

Some embodiments of the present disclosure are described in conjunction with a network device and a terminal device, wherein the terminal device may also be referred to as a user equipment (UE), an access terminal, a subscriber unit, a subscriber station, a mobile terminal, a mobile station, a remote station, a remote terminal, a mobile device, a user terminal, a terminal, a wireless communication device, a user agent, or a user device.

The terminal device is a station (ST) in a WLAN, or a cellular phone, a cordless phone, a Session Initiation Protocol (SIP) phone, a wireless local loop (WLL) station, a personal digital assistant (PDA) device, a handheld device with a wireless communication function, a computing device, or another processing device connected to a wireless modem, an in-vehicle device, a wearable device, a terminal device in a next generation communication system, such as an NR network, or a terminal device in an evolved public land mobile network (PLMN), or the like.

In some embodiments of the present disclosure, the terminal device is deployed on the land, for example, indoors or outdoors, handheld, wearable, or in vehicles; or deployed on water (for example, on a ship); or the terminal device is deployed in air (for example, on an airplane, a balloon, or a satellite).

In some embodiments of the present disclosure, the terminal device is a mobile phone, a pad, a computer with a wireless transceiver function, a virtual reality (VR) terminal device, an augmented reality (AR) terminal, a wireless terminal in industrial control, a wireless terminal in self-driving, a wireless terminal in remote medical, a wireless terminal in smart grid, a wireless terminal in transportation safety, a wireless terminal in smart city, a wireless terminal in smart home, or the like.

By way of example but not limitation, in the embodiments of the present disclosure, the terminal device is a wearable device. The wearable device is also referred to as a wearable smart device, which is a generic term for wearable devices, such as glasses, gloves, watches, clothing, and shoes, which are intelligently designed and developed for daily wear by using wearable technologies. The wearable device is a portable device that is directly worn on the body or integrated into the clothing or accessories of the user. The wearable device is not only a hardware device, but also achieves powerful functions through software support as well as data interaction and cloud interaction. The wearable smart device in a broad sense includes devices such as smart watches or smart glasses that have full functionality and large size, and are capable of implementing all or part of functionality without depending on the smart phone, and devices such as various types of smart bracelets and smart jewelries for monitoring physical signs, which are dedicated to a specific type of application functions and need to be used in cooperation with other devices such as the smart phone.

In some embodiments of the present disclosure, the network device is a device for communication with a mobile device, and the network device is an access point (AP) in a WLAN, a base transceiver station (BTS) in a GSM or a CDMA, a NodeB (NB) in a WCDMA, or an evolutional Node B (eNB, or eNodeB) in the LTE network, a relay station, an access point, an in-vehicle device, a wearable device, a network device (gNB) in an NR network, a network device in a future evolved PLMN network, or a network device in an NTN network.

By way of example but not limitation, in the embodiments of the present disclosure, the network device has a mobile characteristics. For example, the network device is a mobile device. In some embodiments, the network device is a satellite, or a balloon station. For example, the satellite is a low Earth orbit (LEO) satellite, a medium Earth orbit (MEO) satellite, a geostationary Earth orbit (GEO) satellite, a high elliptical orbit (HEO) satellite, or the like. In some embodiments, the network device is a base station installed in locations such as land and water.

In some embodiments of the present disclosure, the network device provides services for cells, and the terminal device communicates with the network device over transmission resources (e.g., frequency domain resources or frequency spectrum resources) used by the cell, which is a cell corresponding to the network device (e.g., a base station). The cell is a base station corresponding to a macro base station or a small cell. The small cell herein includes a metro cell, a micro cell, a pico cell, or a femto cell. The small cells are characterized by a small coverage area and low transmission power, which are suitable for providing high-speed data transmission services.

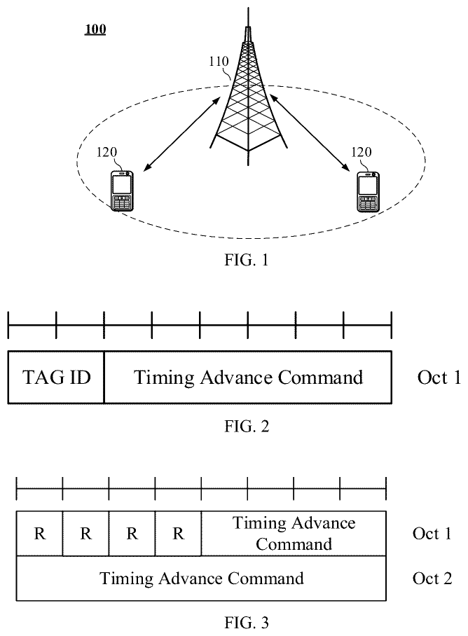

FIG. 1 illustrates a communication system 100 as an example. The communication system includes a network device 110 and two terminal devices 120. In some embodiments, the communication system 100 includes a plurality of network devices 110, and a coverage area of each of the network devices 110 includes other numbers of terminal devices 120, which are not limited in the embodiments of the present disclosure.

In some embodiments, the communication system 100 further includes other network entities such as a mobility management entity (MME) and an access and mobility management function (AMF), which is not limited in the embodiments of the disclosure.

The network devices further include an access network device and a core network device. That is, the wireless communication system further includes a plurality of core networks for communicating with the access network device. The access network device is an evolutional Node B (eNB or e-NodeB), a macro Node B, a micro Node B (also known as “small node B”), a micro-micro Node B, an AP, a transmission point (TP), or a next-generation Node B (gNodeB) in an LTE system, an NR system, or an authorized auxiliary access long-term evolution (LAA-LTE) system.

It is understandable that a device having communication functions in networks/systems according to the embodiments of the present disclosure is referred to as a communication device. Taking the communication system illustrated in FIG. 1 as an example, the communication devices include a network device and a terminal device having a communication function, wherein the network device and the terminal device are specific devices according to the embodiments of the present disclosure, which are not repeated herein. The communication device further includes other devices in the communication system, such as a network controller or a mobile management entity, which are not limited in the embodiments of the present disclosure.

It should be understood that the terms “system” and “network” are often used interchangeably herein. The term “and/or” herein is merely a way to describe an association relationship between associated objects, indicating that there are three possible relationships. For example, the phrase “A and/or B” means (A), (B), or (A and B). In addition, the symbol “/” herein generally indicates an “or” relationship between the associated objects.

It should be understood that the term “indicate” in the embodiments of the present disclosure is a direct indication, an indirect indication, or an indication that there is an associated relationship. For example, the phrase “A indicating B” means that A indicates B directly, e.g., B is acquired by A; or that A indicates B indirectly, e.g., A indicates C by which B may be acquired; or that an association is present between A and B.

In the description of the embodiments of the present disclosure, the term “correspond” may indicate a direct or an indirect correspondence relationship between two objects, an association relationship between two objects, a relationship of indicating and being indicated, configuring and being configured, or the like.

For ease of understanding of the technical solutions according to the embodiments of the present disclosure, the relevant technologies of the embodiments of the present disclosure are described hereinafter, and the following relevant technologies may be combined with the technical solutions of the embodiments of the present disclosure in any combination as an optional option, and all of them shall fall within the protection scope of the embodiments of the present disclosure.

### 1. Timing Advance (TA)

In the current new radio (NR) standard, user equipment (UE) may be configured with, for example, up to four timing advance groups (TAGs) within one cell group (CG). The radio resource control (RRC) configuration of the TAGs can refer to the following example. Generally, one CG is capable of including a plurality of serving cells, and each of the serving cells will be assigned a timing advance group identity (TAG-Id).

Example RRC configuration of TAG:

| | |
|---|---|
| -- ASN1START | |
| -- TAG-TAG-CONFIG-START | |
| TAG-Config ::= SEQUENCE { | |
| tag-ToReleaseList SEQUENCE (SIZE | OPTIONAL, -- |
| (1..maxNrofTAGs)) OF TAG-Id | |
| Need N | |
| tag-ToAddModList SEQUENCE (SIZE | OPTIONAL -- |
| (1..maxNrofTAGs)) OF TAG | |
| Need N | |
| } | |
| TAG ::= SEQUENCE { | |
| tag-Id TAG-Id, | |
| timeAlignmentTimer TimeAlignmentTimer, | |
| ... | |
| } | |
| TAG-Id ::=INTEGER (0..maxNrofTAGs−1) | |
| TimeAlignmentTimer ::= ENUMERATED {ms500, | |
| ms750, ms1280, ms1920, ms2560, ms5120, | |
| ms10240, infinity} | |
| -- TAG-TAG-CONFIG-STOP | |
| -- ASN1STOP | |

An example formula for calculating the amount of a TA of the UE is as follows. A downlink reference of the TA of the UE is the first symbol of the downlink channel or the slot where the channel is located received by the UE, and the transmission is advanced accordingly.

$$( {N}_{TA} + {N}_{TA , offset} ) * {T}_{C}$$

In one CG, each serving cell may be pre-configured with a TA offset, n-TimingAdvanceOffset, which is N_{TA,offset} in the formula. The TA adjustment (N_{TA}) is performed based on a pre-configured offset. T_{C} is the smallest time unit in the NR system, wherein T_{C}=1/(4096*480 kHz). N_{TA} may be differentially adjusted by a medium access control-control element (MAC CE) of a network (NW). That is, a new TA adjustment is made by moving forward or backward in time based on an old TA, with an example formula as follows:

$${N}_{( TAnew )} = {N}_{( TAold )} + ( {T}_{A} - 31 ) * 16 * 64 / {2}^{μ}$$

The first TA adjustment mode is a TA differential adjustment format based on MAC CE, which is illustrated as follows. That is, T_{A} smallest time units are adjusted based on a previous TA, and the granularity of the TA adjustment is the TAG.

Referring to FIG. 2, TAG Identity (TAG ID) is illustrated. This field indicates a TAG identity of an addressed TAG. The TAG containing the special cell (SpCell) has the TAG Identity 0. The length of this field is 2 bits. In some embodiments, the SpCell includes a primary cell (Pcell) and a primary secondary cell (Pscell).

Timing Advance Command is illustrated. This field indicates the index value TA (0, 1, 2 . . . 63) used to control the amount of timing adjustment that a MAC entity has to apply (as specified in TS 38.213 [6]). The length of this field is 6 bits.

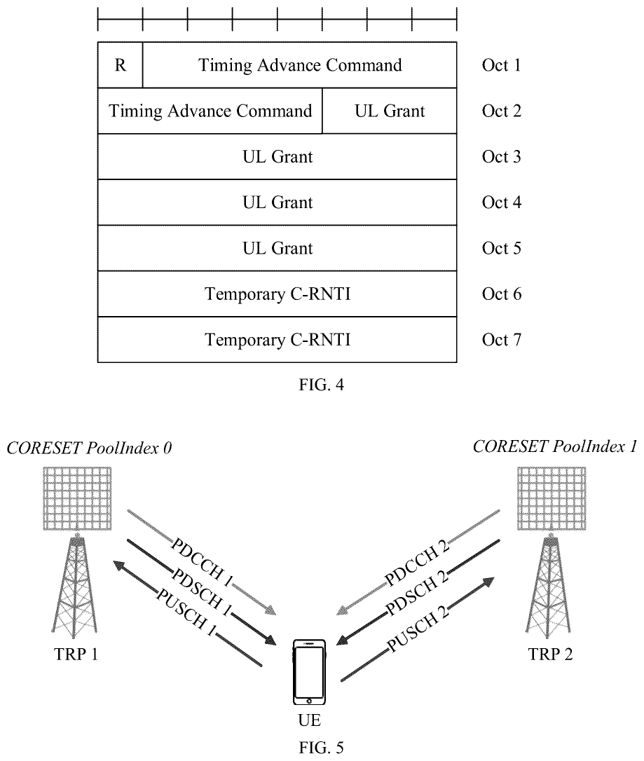

The second TA adjustment mode is an adjustment of the absolute value of the TA. That is, it does not require consideration of the previous TA value. The NW directly provides an absolute value N_{TA} over an absolute MAC CE (refer to FIG. 3) or a random access response (RAR) MAC payload (refer to FIG. 4). The value range of the absolute value is 0 to 3846, and the TA adjustment range is N_{TA}=T_{A}*16*64*24. The two modes for acquiring the TA occur during a random access procedure. The acquired TA applies to a TAG corresponding to a target cell of the random access, such that there is no need to include a TAG-ID. For example, the absolute MAC CE is used in a two-step random access procedure, and the two-step random access procedure can only be initiated toward the SpCell. Therefore, the MAC CE applies to the primary timing advance group (PTAG) corresponding to the MAC entity, that is, the PTAG includes the SpCell.

Referring to FIG. 3, a Timing Advance Command is illustrated. This field indicates the index value TA used to control the amount of timing adjustment that the MAC entity has to apply in TS 38.213 [6]. The size of this field is 12 bits.

R: Reserved bit, set to “0”.

### 2. Maintenance of the TA of UE

The validity of the TA is maintained using a TA timer. Upon receiving a MAC CE or RAR that includes the TA command, the UE starts or restarts the timer. In the case that the timer times out, the UE performs behaviors such as releasing resources and clearing buffers.

### 3. Uplink Multi-Transmission Reception Point (TRP) Operation

In 3GPP, uplink physical uplink control channel (PUCCH)/physical uplink shared channel (PUSCH) repetition based on multiple TRPs is supported. The objective is to enhance uplink coverage and improve transmission reliability. The UE needs to transmit the PUCCH/PUSCH carrying the same content to different TRPs.

With respect to the PUSCH repetition, multi-PUSCH repetition based on a single downlink control information (sDCI) is supported, and the PUSCH is sequentially transmitted to different TRPs using one TA. With respect to multi-PUSCH transmission based on multiple downlink control information (mDCI), because there may not be an ideal backhaul between multiple TRPs as a connection, independent scheduling of UEs by multiple TRPs may cause temporal overlap of different PUSCHs/PUCCHs. As a result, support for TRP-specific TA updates or indications is required.

Currently, 3GPP is developing a mechanism for a UE to transmit the PUCCH/PUSCH to multiple TRPs simultaneously using multiple antenna panels. Although, with the configuration involving multiple uplink transmission antenna panels and multiple TRP reception, the UE can use only one TA for advance transmission within one component carrier (CC). This limitation clearly needs to be addressed, i.e., enabling support for TRP-specific TA updates or indications.

In the scenario of intra-cell multiple transmission reception points (mTRPs), as illustrated in FIG. 5, each TRP is capable of scheduling its physical downlink shared channel (PDSCH) transmissions over its own downlink control information (DCI). Each TRP may also (not currently supported) schedule its own PUSCH transmissions (refer to the arrows for PUSCH 1 and PUSCH 2 in FIG. 5). TRP 1 and TRP 2 are capable of using the same physical cell identifier (PCI).

In the mDCI-mTRP operation, compared to the single DCI-multi-TRP (sDCI-mTRP) operation, the demand for the DCI is higher and independent scheduling is performed by each TRP, thereby increasing the number of control resource sets (CORESETs) that are occupied by the DCI. Moreover, the CORESETs are grouped using their RRC parameter, the CORESET pool index (PoolIndex). For example, CORESETs with a CORESETPoolIndex of “0” are grouped together and correspond to one TRP. CORESETs with a CORESETPoolIndex of “1” are grouped together and correspond to another TRP. In the case that the NW does not configure CORESETPoolIndex for a CORESET, the default value of the CORESETPoolIndex is “0”.

For inter-cell mTRPs, TRP 1 in FIG. 5 may be understood as a reference TRP, i.e., the TRP accessed by the UE during initial access. The UE has already established uplink and downlink synchronization, and TRP 1 has a dedicated PCI #1. For other TRPs, because the NW can select one TRP from up to seven TRPs to serve the UE, these TRPs have PCIs different from that of the reference TRP and typically do not have prior uplink or downlink synchronization established with the UE.

In the related art, the UE's TA is updated and maintained based on the TAG, with each serving cell being associated with one TAG. At the latest radio access network 1 (RAN 1) meeting, RAN 1 agreed to support a TRP-based TA indication scheme. That is, in the mTRP scenario, two TRPs of one serving cell may have different TAs, and the TAs of the two TRPs are associated with different TAGs. That is, each serving cell may be associated with two TAGs.

Related TAGS may be classified as the PTAG and the STAG. In a carrier aggregation/dual connectivity (CA/DC) scenario, the TAG that the Pcell/Pscell belongs to is the PTAG, and the TAG that the secondary cell (Scell) belongs to is the STAG. Then, in the case that each serving cell is associated with two TAGs in the mTRP scenario, the current PTAG/STAG may result in one serving cell having two PTAGs. In the related art, in the case that the timer associated with the PTAG times out, the UE releases uplink resources for all serving cells and clears the corresponding hybrid automatic repeat request (HARQ) buffer. In the mTRP scenario, in the case that another TRP in the Pcell can still operate, the UE does not need to release all resources.

The method for communication according to the embodiments of the present disclosure can provide a new way to determine the TAG, allowing the UE to better maintain the TA, thereby ensuring the continuity of uplink services.

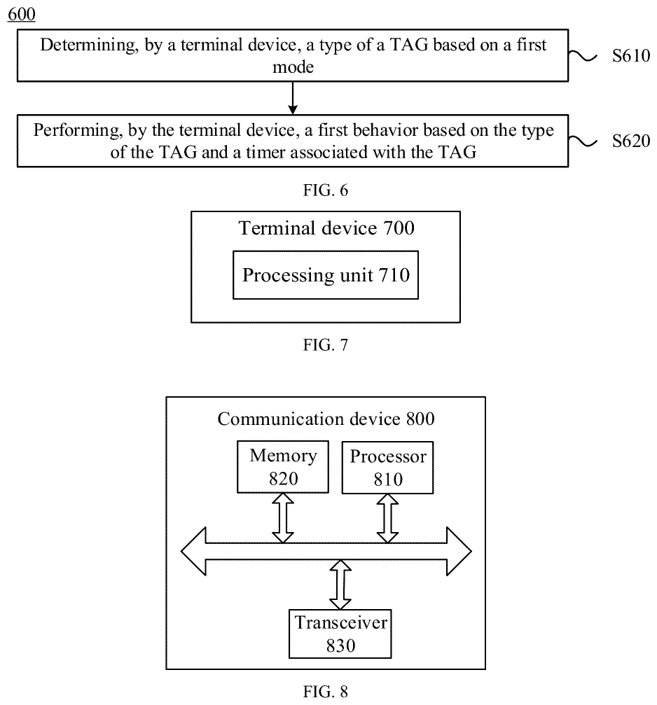

FIG. 6 is a schematic flowchart of a method 600 for communication according to some embodiments of the present disclosure. In some embodiments, the method is applicable to the system illustrated in FIG. 1 but is not limited thereto. The method includes at least some of the following content.

In S610, a terminal device determines a type of a TAG based on a first mode.

In S620, the terminal device, based on the type of the TAG and a timer associated with the TAG, performs a first behavior.

In the embodiments of the present disclosure, the type of the TAG includes various types, such as a PTAG or a STAG. In a multi-TRP scenario, by determining whether the TAG is the PTAG or the STAG, behaviors corresponding to different types of the TAG can be performed. For example, decision for whether to release resources is more flexible, which is beneficial to ensuring the continuity of services.

One cell group (CG) and/or one medium access control (MAC) entity may be associated with one or more PTAGs, which will be explained hereinafter.

In some embodiments, in the case that at least one of one CG or one MAC entity is associated with one PTAG, the first mode includes at least one of:
a TAG associated with an initially accessed cell and/or TRP in ta Pcell and/or Pscell being a first TAG;
a TAG associated with a TRP associated with control resource set 0 (CORESET 0) in a Pcell and/or Pscell being a first TAG;
a TAG associated with a TRP that receives a common channel in a Pcell and/or Pscell being a first TAG;
a TAG associated with a first control resource set index in a Pcell and/or Pscell being a first TAG and a TAG associated with a second control resource set index being a second TAG;
a TAG associated with a TRP whose transmission configuration indicator (TCI) state is associated with beam information of a serving cell in a Pcell and/or Pscell being a first TAG;
a TAG associated with a cell and/or TRP that initially initiates a random access procedure during an addition/change process of a secondary cell group (SCG) being a first TAG;
a TAG associated with a Pcell and/or Pscell being a first TAG; or any TAG other than the first TAG being a second TAG.

In some embodiments of the present disclosure, the beam information of the serving cell associated with the TCI state of the TRP includes a synchronization signal and PBCH block (SSB) and/or a channel state information-reference signal (CSI-RS) of the serving cell.

In some embodiments, in the case that at least one of one CG or one MAC entity is associated with two PTAGs, the first mode includes at least one of:
a TAG associated with at least one of a Pcell or Pscell being a first TAG; or
a TAG associated with the Scell being a second TAG.

In some embodiments of the present disclosure, the first TAG is the PTAG, and the second TAG is the STAG.

In some embodiments, in the case that one TAG includes at least one sub-TAG, the first mode includes at least one of:
at least one of each PTAG or each secondary timing advance group (STAG) including sub-TAGs as a third TAG and a fourth TAG; or
a third TAG being associated with a first TRP, and a fourth TAG being associated with a second TRP.

For example, in the case that a certain PTAG is the first TAG and the sub-TAGs of the first TAG include the third TAG and the fourth TAG, then the first behavior corresponding to the third TAG refers to the first behavior corresponding to the first TAG, i.e., the PTAG, and the first behavior corresponding to the fourth TAG refers to the first behavior corresponding to the second TAG, i.e., the STAG.

For another example, in the case that a certain STAG is the second TAG and the sub-TAGs of the second TAG include the third TAG and the fourth TAG, then the first behavior corresponding to the third TAG refers to the first behavior corresponding to the first TAG, i.e., the PTAG, and the first behavior corresponding to the fourth TAG refers to the first behavior corresponding to the second TAG, i.e., the STAG.

In some embodiments, the identity of the TRP includes at least one of:
a TCI state;
spatial relation information;
a control resource pool index;
a downlink reference signal group;
at least one of an uplink channel or a reference signal for a semi-persistent uplink channel;
at least one of an uplink channel or a reference signal for a semi-persistent reference signal; or
an identity of a TAG.

In some embodiments of the present disclosure, the identity of the TRP is associated with the identity of the TAG.

In some embodiments, in the case that a timer associated with the first TAG times out, the first behavior includes at least one of:
releasing a resource associated with the current serving cell;
releasing resources associated with all serving cells;
triggering a random access procedure to recover a TA;
taking no action, and performing a corresponding behavior in the case that all TAG timers associated with the cell associated with the first TAG have timed out;
releasing a resource associated with the first TAG; or
releasing a resource associated with the first TRP.

In some embodiments of the present disclosure, the cell associated with the first TAG is one Pcell, one Pscell or one Scell. All TAG timers associated with the cell associated with the first TAG include TAG timers associated with all TRPs in one Pcell, Psell or Scell associated with the first TAG. For example, in the case that there are two TRPs operating in one Pcell associated with the first TAG, the UE performs the first behavior besides taking no action only after the TAG timers for both of the TRPs time out. For another example, the first TAG is associated with at least one Scell. In the case that there are two TRPs operating in a certain Scell associated with the first TAG, the UE performs the first behavior besides taking no action only after the TAG timers for both of the TRPs time out.

In the embodiments of the present disclosure, after the terminal device takes no action, the corresponding behavior performed in the case that all TAG timers have timed out is at least one behavior from the first behavior excluding inaction. For example, after all TAG timers have timed out, the resource of the current serving cell, the resource associated with the first TAG, or the like, are released. The resource of the serving cell can includes, for example, a HARQ buffer, a sounding reference signal (SRS), a PUCCH, an SPS, a CG, or the like.

For example, in the case that the timer associated with the first TAG times out and the first TAG is associated with at least one of the Pcell or the Pscell, the first behavior includes at least one of:
releasing resources associated with all serving cells;
triggering a random access procedure to recover a TA;
taking no action, and performing a corresponding behavior in the case that all TAG timers associated with TRPs in at least one of the Pcell or the Pscell have timed out;
releasing a resource associated with the first TAG; or
releasing a resource associated with the first TRP.

For another example, in the case that the timer associated with the first TAG times out and the first TAG is associated with the Scell, the first behavior includes at least one of: releasing a resource associated with the current serving cell;
triggering a random access procedure to recover a TA;
taking no action, and performing a corresponding behavior in the case that all TAG timers associated with TRPs in the Scell have timed out;
releasing a resource associated with the first TAG; or
releasing a resource associated with the first TRP.

In the embodiments of the present disclosure, the serving cell of the terminal device may differ when the first TAG is associated with a Pcell or Pscell compared to when the first TAG is associated with a Scell. For example, in the case that the first TAG is associated with the Pcell or the Pscell, because the Pcell or the Pscell is the primary serving cell, the terminal device releases resources of all serving cells when the TAG timers have all timed out. For another example, in the case that the first TAG is associated with the Scell, the invalidation of a Scell's TA does not affect the normal transmission within other Pcells or Scells, so the terminal device releases the resource of the current serving cell when the TAG timers have all timed out.

In some embodiments, in the case that the timer associated with the second TAG times out, the first behavior includes at least one of:
releasing a resource associated with the current serving cell;
releasing resources associated with all serving cells;
triggering a random access procedure to recover a TA;
taking no action, and performing a corresponding behavior in the case that all TAG timers of a cell associated with the second TAG have timed out;
releasing a resource associated with the second TAG; or
releasing a resource associated with the second TRP.

In some embodiments of the present disclosure, the cell associated with the second TAG is one Pcell, one Pscell or one Scell. All TAG timers associated with the cell associated with the second TAG include TAG timers associated with all TRPs in the Pcell, Psell or Scell associated with the second TAG.

For example, in the case that the timer associated with the second TAG times out and the second TAG is associated with at least one of the Pcell or the Pscell, the first behavior includes at least one of:
releasing resources associated with all serving cells;
triggering a random access procedure to recover a TA;
taking no action, and performing a corresponding behavior in the case that TAG timers associated with all TRPs in at least one of the Pcell or the Pscell have timed out;
releasing a resource associated with the first TAG; or
releasing a resource associated with the first TRP.

For another example, in the case that the timer associated with the second TAG times out and the second TAG is associated with the Scell, the first behavior includes at least one of:
releasing a resource associated with the current serving cell;
triggering a random access procedure to recover a TA;
taking no action, and performing a corresponding behavior in the case that all TAG timers associated with the Scell have timed out;
releasing a resource associated with the second TAG; or
releasing a resource associated with the second TRP.

In some embodiments, in the case that the timer associated with the third TAG times out, the first behavior includes at least one of:
releasing a resource associated with the current serving cell;
releasing resources associated with all serving cells;
triggering a random access procedure to recover a TA;
taking no action, and performing a corresponding behavior in the case that all TAG timers associated with the cell associated with the third TAG have timed out;
releasing a resource associated with the third TAG; or
releasing a resource associated with the third TRP.

In some embodiments of the present disclosure, the cell associated with the third TAG is one Pcell, one Pscell or one Scell. All TAG timers associated with the cell associated with the third TAG include TAG timers associated with all TRPs in the Pcell, Psell or Scell associated with the third TAG. The third TAG is similar to the first TAG. Specific examples can refer to the relevant description of the first TAG.

In some embodiments, in the case that the timer associated with the fourth TAG times out, the first behavior includes at least one of:
releasing a resource associated with the current serving cell;
releasing resources associated with all serving cells;
triggering a random access procedure to recover a TA;
taking no action, and performing a corresponding behavior in the case that all TAG timers associated with the cell associated with the fourth TAG have timed out, wherein the cell associated with the fourth TAG may be at least one of a Pcell, a Pscell or a Scell;
releasing a resource associated with the fourth TAG; or
releasing a resource associated with the fourth TRP.

In some embodiments of the present disclosure, the cell associated with the fourth TAG is one Pcell, one Pscell or one Scell. All TAG timers associated with the cell associated with the fourth TAG include TAG timers associated with all TRPs in the Pcell, Psell or Scell associated with the fourth TAG. The fourth TAG is similar to the second TAG. Specific examples can refer to the relevant description of the second TAG.

In some embodiments, in the case that the timer associated with the TAG times out, the first behavior further includes: transmitting a TA recovery request. In some embodiments of the present disclosure, the TAG that transmits the TA recovery request based on the timer timeout is any one of the first TAG, the second TAG, the third TAG or the fourth TAG.

In some embodiments, the TA recovery request is transmitted over at least one of:
a MAC CE;
an uplink scheduling request (SR); or
a random access procedure.

For example, the TA recovery request is carried over the MAC CE.

In some embodiments, the MAC CE carries at least one of:
a TAG identity;
a TRP identity;
a serving cell identity;
downlink (DL) timing information of the TRP measured by the terminal device; or
a layer 1 reference signal received power (L1-RSRP) measurement result.

In the embodiments of the present disclosure, for the first TAG or the third TAG, the MAC CE carries the DL timing information of the first TRP measured by the terminal device. For the second TAG or the fourth TAG, the MAC CE carries the DL timing information of the second TRP measured by the terminal device, or the downlink timing difference between the first TRP and the second TRP.

In some embodiments, the resource used by the MAC CE includes at least one of: a resource dynamically scheduled by the physical downlink control channel (PDCCH); a CG resource; or a resource indicated in the RAR.

In some embodiments, the SR is configured for each TRP and/or each TAG. For example, the SR is configured per TRP. Different TRPs correspond to different SRs. The TA recovery request may be reported over the SR. In the case that the TAG's TA timer times out, the UE triggers the SR report corresponding to the TAG.

In some embodiments, the SR of at least one of the TAG or the TRP is associated with the PUCCH resource of the TRP.

In some embodiments, the SR of at least one of the TAG or the TRP is associated with the PUCCH resource of another TRP in the serving cell.

In some embodiments, the random access procedure is initiated based on the TAG with an invalid TA and the random access (RA) resource associated with at least one of the TAG or the TRP.

In some embodiments, in the case that the TA associated with at least one of the first TRP, the first TAG or the third TAG is invalid, the TA is recovered by a random access procedure triggered by the terminal device. In the embodiments of the present disclosure, the first TRP is associated with the first TAG or the third TAG, and the second TRP is associated with the second TAG or the fourth TAG. The first TRP may be the primary TRP, and the second TRP may be the secondary TRP. For example, the first TRP is used to receive a common channel and monitor CORESET 0; or the first TRP is the TRP accessed by the UE during initial access or the TRP for the initial random access procedure. The second TRP is used to receive and/or transmit a UE-specific channel.

In some embodiments, for a terminal device configured with mTRPs, the mode for configuring a random access resource includes at least one of the following.
Mode 1: For all or part of the random access occasions (RACH occasion, RO) within an RO set, the preambles associated with each of the ROs are categorized to a first preamble set and a second preamble set. The first preamble set is associated with the first TAG and is used by the terminal device to select a preamble from the first preamble set to initiate a random access procedure to the TRP associated with the first TAG in the case that the TA of the first TAG is invalid. The second preamble set is associated with the second TAG and is used by the terminal device to select a preamble from the second preamble set to initiate a random access procedure to the TRP associated with the second TAG in the case that the TA of the second TAG is invalid.
Mode 2: Each TRP is configured with different RO resource sets. A first RO set is used by the terminal device to initiate a random access procedure to the TRP associated with a first TAG. A second RO set is used by the terminal device to initiate a random access procedure to the TRP associated with a second TAG.
Mode 3: Each TRP is configured with different SSB and/or CSI-RS sets. The RO and preamble resource associated with at least one of a first SSB or a first CSI-RS are used by the terminal device to initiate a random access procedure to the TRP associated with a first TAG. The RO and preamble resource associated with at least one of a second SSB or second CSI-RS are used by the terminal device to initiate a random access procedure to the TRP associated with a second TAG.
Mode 4: Each TRP is configured with different random access related configurations, which include a RACH common configuration, a RACH dedicated configuration and a RACH generic configuration.

In some embodiments, the terminal device is triggered to initiate a random access procedure to a TRP:
in the case that the terminal device initiates a contention-based random access procedure to the associated TRP based on the random access resource associated with the TRP; or
in the case that the terminal device receives indication information from the network side, wherein the indication information instructs the terminal device to initiate a non-contention-based random access resource to a target TRP.

For example, with respect to the first TAG or the third TAG, the terminal device initiates a contention-based random access procedure to the associated TRP based on the random access resource associated with the first TRP. With respect to the second TAG or the fourth TAG, the terminal device initiates a contention-based random access procedure to the associated TRP based on the random access resources associated with the second TRP.

In some embodiments of the present disclosure, the target TRP is the first TRP or the second TRP.

In some embodiments, the indication information is carried over the DCI or the MAC CE.

In some embodiments, the indication information includes at least one of:
a control resource set pool index (CORESETPoolIndex);
a TCI state (TCI-state);
spatial relation information;
a TAG identity (TAG ID);
a PCI;
a synchronization resource block index (SSB index);
a preamble index; or
a physical random access channel (PRACH) mask index.

The control resource set pool index, the TCI state, the spatial relation information, the TAG identity, and the PCI are referred to as target TRP information.

In some embodiments of the present disclosure, the terminal device performs the first behavior based on the type of the TAG and the timer associated with the TAG, which is beneficial for improving the continuity of services, such as uplink services.

In a specific application scenario, for example, in an mTRP multi-TA scenario, an example of the mode for determining the TAG is as follows. The mode is applicable to both inter-cell mTRP scenarios and intra-cell mTRP scenarios.
Option 1: Single PTAG (one CG/MAC entity is associated with only one PTAG). Specifically, the mode/condition for the UE to determine whether the TAG is a PTAG (first TAG) or an STAG (second TAG) includes at least one of the following.
a. The TAG associated with the initially accessed cell/TRP in the Pcell/Pscell is the first TAG.
b. The TAG associated with (or referred as to corresponding to) the TRP associated with CORESETO in the Pcell/Pscell is the first TAG.
c. The TRP receiving the common channel in the Pcell/Pscell is the first TAG.
d. In the Pcell/Pscell, a CORESETPoolIndex 0 corresponds to the first TAG, and a CORESETPoolIndex 1 corresponds to the second TAG, or vice versa. That is, in some embodiments, a CORESETPoolIndex 1 corresponds to the first TAG, and a CORESETPoolIndex 0 corresponds to the second TAG.
e. The TAG associated with the TRP of the TCI state associated with the serving cell synchronization signal and PBCH block/channel state information-reference signal (SSB/CSI-RS) is the first TAG.
f. During the addition/change process of an SCG, the TAG associated with the cell/TRP that initially initiates the random access procedure is the first TAG.
g. Except for the first TAG associated with the Pcell/Pscell, all others are the second TAGs.
Option 2: Dual PTAG (one CG/MAC entity is associated with two PTAGs).
a. The TAG associated with the Pcell/Pscell is the first TAG.
b. Other TAGs associated with the Scell are the second TAGs.
Option 3: Sub-TAG. For example, each TAG (PTAG or STAG) further includes at least one sub-TAG.
a. Each PTAG/STAG distinguishes between a third TAG and a fourth TAG.
b. The third TAG is associated with the first TRP, and the fourth TAG is associated with the second TRP.

According to Option 1, Option 2, or Option 3, TRPs can be identified and/or distinguished by at least one of the following modes.
a. Different TCI states/spatial relation information, such as a TCI state list or a spatial relation list.
b. Different CORESETPoolIndexes.
c. Different DL reference signal (RS) groups. For a UL transmission, UE adopts the TAG associated with the DL RS group to which the PL RS of the UL transmission belongs.
d. Different uplink (UL) channels, multiple RSs directly for semi-static UL channels, multiple RSs, or dynamic resources. Examples of the multiple RSs include: a primary CSI PUCCH (P CSI PUCCH), a primary SRS (P SRS), and a CG PUSCH.
e. A TAG identity, wherein the TAG identity is associated with TRP identity.

Furthermore, the UE maintains the TA timer of the TAG. In the case that the TA timer times out, the UE's behaviors include but are not limited to at least one of the following.
a. In the case that the TA timer associated with the first TAG times out:
i. In the case that the first TAG is associated with the Pcell/Pscell:
(1) releasing resources associated with all serving cells; or
(2) triggering RACH to recover a TA; or
(3) taking no action, and performing a corresponding behavior in the case that all timers associated with the Pcell/Pscell, such as the two TAG timers, have timed out.
ii. In the case that the first TAG is associated with the Scell:
(1) releasing a resource associated with the current serving cell; or
(2) taking no action, and performing a corresponding behavior in the case that all timers associated with the Scell have timed out; or
(3) releasing a resource associated with the first TAG/TRP.
b. In the case that the TA timer of the second TAG times out:
i. In the case that the second TAG is associated with the Pcell/Pscell:
(1) releasing resources associated with all serving cells; or
(2) triggering a RACH to recover a TA; or
(3) taking no action, and performing a corresponding behavior in the case that all timers associated with the Pcell/Pscell have timed out; or
(4) releasing a resource associated with the second TAG/second TRP.
ii. In the case that the second TAG is associated with the Scell:
(1) releasing a resource associated with the current serving cell; or
(2) taking no action, and performing a corresponding behavior in the case that all timers associated with the Scell have timed out; or
(3) releasing a resource associated with the second TAG/second TRP; or
(4) optionally, transmitting, by the UE, a TA recovery request after the TA timer associated with the second TAG times out, which can ensure synchronization with the network side by recovering the TA.

The UE's behavior for the timeout of the timer associated with the third TAG can refer to the description related to the first TAG. The UE's behavior for the timeout of the timer associated with the fourth TAG can refer to the description related to the second TAG.

Furthermore, the TA recovery request is transmitted over at least one of the following modes.
(4-1) MAC CE based: The TA recovery request is transmitted over the MAC CE, which carries the TAG/TRP ID, and optionally, the MAC CE further carries the DL timing information measured by the UE for the TRP. The resource available to the MAC CE includes a resource dynamically scheduled by the PDCCH, a CG resource, or a resource indicated in the RAR.
(4-2) SR: The TA recovery request may be reported over the SR. In the case that the TA timer of the TAG times out, the UE triggers the reporting for the SR, wherein the SR is configured per TRP or per TAG. In some embodiments, the SR of the TAG/TRP is associated with a PUCCH resource of another TRP in the serving cell, or the PUCCH resource of the TRP.
(4-3) Initiating a random access procedure: For example, a random access procedure is initiated based on the TAG with an invalid TA and a random access resource associated with the TAG/TRP. In some embodiments, the network configures the random access resource associated only with the first TRP. That is, only invalidity of the TA associated with the first TRP/TAG can be recovered by a RACH procedure triggered autonomously by UE. Other TRP/TAGs can only be recovered by a network-triggered random access procedure, or using modes such as the MAC CE or the SR.
(5) For UEs configured with mTRPs, the mode for configuring a RACH resource further includes at least one of the following.
(5-1) For all or part of the ROs within an RO set, the preambles associated with each of the ROs are further categorized into a preamble set #1 and a preamble set #2. The preamble set #1 is associated with the first TAG. In the case that the TA of the first TAG is invalid, the UE selects a preamble from the preamble set #1 to initiate a random access procedure to the TRP corresponding to the first TAG. The preamble set #2 is associated with the second TAG. In the case that the TA of the second TAG is invalid, the UE selects a preamble from the preamble set #2 to initiate a random access procedure to the TRP corresponding to the second TAG.
(5-2) The network configures different RO resource sets for each TRP. For example, a first RO set and a second RO set are configured. The first RO set is used for the UE to initiate a random access procedure to the TRP corresponding to the first TAG. The second RO set is used for the UE to initiate a random access procedure to the TRP corresponding to the second TAG.
(5-3) The network configures different SSB/CSI-RS sets for each TRP. For example, a first SSB/CSI-RS set and a second SSB/CSI-RS set are configured. The RO and preamble resource associated with the first SSB/CSI-RS set are used for the UE to initiate a random access procedure to the TRP corresponding to the first TAG. The RO and preamble resource associated with the second SSB/CSI-RS set are used for the UE to initiate a random access procedure to the TRP corresponding to the second TAG.
(5-4) The network configures different random access related configurations for each TRP, including at least one of a RACH-common configuration (ConfigCommon), a RACH-dedicated configuration (ConfigDedicated) or a RACH-generic configuration (ConfigGeneric).
(6) A UE is triggered to initiate a random access to a TRP in the least one of the following cases.
(6-1) The UE initiates a contention-based random access procedure to the corresponding TRP based on the random access resource associated with the TRP.
(6-2) The UE receives indication information from the network side, wherein the indication information instructs the UE to initiate a non-contention-based random access resource to the target TRP. The indication information is carried over the DCI or the MAC CE and includes at least one of: target TRP information, an SSB index, a preamble index, or an RO mask. For example, the target TRP information includes at least one of a CORESETPoolIndex, a TCI-state, spatial relation information, a TAG ID or a PCI.

### Example 1: Only One PTAG Within a CG

For one serving cell, in the case that the serving cell is a Pcell or Pscell and the serving cell is associated with two TAGs, a TAG corresponding to a first TRP is a PTAG, and a TAG corresponding to a second TRP is an STAG; in the case that the serving cell is a Scell, each of at least one TAG associated with the cell is an STAG.

One serving cell associated with two TAGs indicates that the serving cell is configured with mTRPs, wherein different TRPs are either in the same cell (intra-cell mTRPs) or in different cells (inter-cell mTRPs). Each TAG is associated with one TRP in the serving cell, wherein the representation mode of the TRP includes, but is not limited to, different reference signal sets (such as a TCI state, spatial relation, an SSB, a CSI-RS, a SRS resource, or a primary link (PL) RS), different CORESETPool indexes, or different uplink resources (e.g., a DG, a CG, or a PUCCH).

The UE maintains a TA timer for each TRP/TAG, which includes that the UE, upon receiving TA information of the TRP/TAG (a TA command MAC CE, a RAR, or an absolute TAC MAC CE), starts/restarts the TA timer, and during the operation of the timer, the UE considers the TA of the TRP/TAG to be valid; in the case that the TA timer times out, the UE performs a timeout behavior and/or reports to the network side.
Situation 1: In the case that the TRP/TAG is a TAG in the Pcell or Pscell, the UE performs the first behavior, as detailed in the following options.
Option 1: In the case that the TA timer of another TRP/TAG associated with the serving cell is still in operation, the UE does not perform any operation. That is, the UE only performs the first behavior in the case that the TA timers of both TRPs/TAGs associated with the serving cell have timed out.
Option 2: The UE performs the first behavior based only on whether the TAG associated with the current TA timer is the first TAG.

For example, the first behavior includes at least one of:
releasing resources associated with all serving cells;
triggering the RACH to recover the TA;
taking no action, and performing a corresponding behavior (other first behaviors besides taking no action) in the case that both TAG timers associated with the Pcell have timed out; or
releasing a resource associated with the first TAG/TRP.

### Example 1-1

In the case that the timer of the second TAG in the Pcell times out and the timer of the first TAG is still in operation, the UE performs transmission with the network side based on the first TRP. In some embodiments, the UE triggers a random access procedure to recover the TA of the second TAG.

### Example 1-2

In the case that the timer of the first TAG in the Pcell times out, the UE considers all TA timers timed out and releases related resources in all serving cells, which specifically includes at least one of:
1. flushing all HARQ buffers for all serving cells;
2. notifying a RRC to release PUCCH for all serving cells, if configured;
3. notifying a RRC to release an SRS for all serving cells, if configured;
4. clearing any configured downlink assignments and configured uplink grants;
5. clearing any PUSCH resource for semi-persistent CSI reporting;
6. considering all running timeAlignmentTimers as expired; or
7. maintaining a N_{TA} (defined in TS 38.211 [8]) of all TAGs.

### Example 1-3

Based on Example 1-1, in the case that the timer of the first TAG is still in operation, the UE may choose to release only the related resources on the second TRP associated with the second TAG.
Situation 2: In the case that the TRP/TAG is a TAG in a Scell, the behavior performed by the UE specifically includes at least one of:
1. releasing a resource associated with the current serving cell (i.e., the Scell); or
2. taking no action; or
3. releasing a resource associated with the corresponding TAG/TRP in the serving cell.

### Example 2: One CG/MAC Entity is Associated With Two PTAGs

For one serving cell, in the case that the serving cell is the Pcell or the Pscell and the serving cell is associated with two TAGs, both TAGs are PTAGs. In the case that the serving cell is the Scell, each of at least one TAG associated with the cell is an STAG.

For example, the behavior after a TA timer times out includes the following.

When a timeAlignmentTimer expires:
a. If the timeAlignmentTimer is associated with the PTAG:
i. flushing all HARQ buffers for all serving cells;
ii. notifying a RRC to release a PUCCH for all serving cells, if configured;
iii. notifying a RRC to release an SRS for all serving cells, if configured;
iv. clearing any configured downlink assignments and configured uplink grants;
v. clearing any PUSCH resource for semi-persistent CSI reporting;
vi. considering all running timeAlignmentTimers as expired; or
vii. maintaining a N_{TA} (defined in TS 38.211 [8]) of all TAGs.
b. Else, if the timeAlignmentTimer is associated with an STAG, then for all serving cells belonging to this TAG, perform at least one of the following behaviors:
i. flushing all HARQ buffers;
ii. notifying a RRC to release a PUCCH, if configured;
iii. notifying a RRC to release an SRS, if configured;
iv. clearing any configured downlink assignments and configured uplink grants;
v. clearing any PUSCH resource for semi-persistent CSI reporting; or
vi. maintaining a N_{TA} (defined in TS 38.211 [8]) of this TAG.

In some embodiments, the UE determines a timeout behavior based on whether there are other TRP/TAG-associated TA timers operating in the cell associated with the TAG.

For example, in the case that the timer of the first PTAG in the Pcell times out, and the timer of the second PTAG is still in operation, then the UE performs transmission with the network side based on the first TRP associated with the first PTAG. In some embodiments, the UE triggers a random access procedure to recover the TA of the first TAG.

In the case that the TA timer is associated with an STAG, the UE's behavior is similar to Example 1, which may includes:
1. releasing a resource associated with the cell; or
2. taking no action; or
3. releasing a resource associated with the corresponding TAG/TRP in the serving cell.

### Example 3: One TAG Includes Two Sub-TAGs

For each serving cell, the UE considers the TAG associated with the Pcell/Pscell as a PTAG and the TAG associated with the Scell as an STAG. Furthermore, each PTAG/STAG is further categorized into a third TAG and a fourth TAG, wherein the third TAG is associated with the first TRP and the fourth TAG is associated with the second TRP.

TA timers are maintained based on each sub-TAG, and the timer timeout behavior can refer to Example 1 or Example 2.

In the embodiments of the present disclosure, a mode for determining a TAG is provided, allowing the UE can clarify the mode for maintaining the TAG and the behavior to be performed in the case that the corresponding TA timer times out in an mTRP scenario, which is beneficial for maintaining the continuity of uplink services.

FIG. 7 is a schematic block diagram of a terminal device 700 according to some embodiments of the present disclosure. The terminal device 700 may include: a processing unit 710.

The processing unit 710 is configured to: determine the type of a TAG based on a first mode; and perform a first behavior based on the type of the TAG and a timer associated with the TAG.

In some embodiments, in the case that at least one of one CG or one MAC entity is associated with one PTAG, the first mode includes at least one of:
a TAG associated with an initially accessed cell and/or TRP being a first TAG;
a TAG associated with a TRP associated with control resource set 0 being a first TAG;
a TAG associated with a TRP receiving a common channel being a first TAG;
a TAG associated with a first control resource set index being a first TAG, and a TAG associated with a second control resource set index being a second TAG;
a TAG associated with a TRP whose TCI state is associated with beam information of a serving cell being a first TAG;
during addition and/or change process of an SCG, a TAG associated with a cell and/or TRP that initially initiates a random access procedure being a first TAG;
a TAG associated with a Pcell and/or Pscell being a first TAG; or
any TAG other than the first TAG being a second TAG.

In some embodiments, in the case that at least one of one CG or one MAC entity is associated with two PTAGs, the first mode includes at least one of:
a TAG associated with at least one of a Pcell or a Pscell being a first TAG; or
a TAG associated with a Scell being a second TAG.

In some embodiments, in the case that one TAG includes at least one sub-TAG, the first mode includes at least one of:
at least one of each PTAG or each STAG including sub-TAGs as a first TAG and a second TAG; or
a first TAG being associated with a first TRP, and a second TAG is associated with a second TRP.

In some embodiments, an identity of the TRP includes at least one of:
a TCI state;
spatial relation information;
a control resource pool index;
a downlink reference signal group;
at least one of an uplink channel or a reference signal for a semi-persistent uplink channel;
at least one of an uplink channel or a reference signal for a semi-persistent reference signal; or
an identity of a TAG.

In some embodiments, in the case that a timer associated with a first TAG times out, the first behavior includes at least one of:
releasing a resource associated with a current serving cell;
releasing resources associated with all serving cells;
triggering a random access procedure to recover a TA;
taking no action, and performing a corresponding behavior in the case that all TAG timers associated with a cell associated with the first TAG have timed out;
releasing a resource associated with the first TAG; or
releasing a resource associated with a first TRP.

In some embodiments of the present disclosure, the cell associated with the first TAG is one Pcell one Pscell or one Scell. All TAG timers associated with the cell associated with the first TAG include all TAG timers associated with TRPs in the Pcell, Psell or Scell associated with the first TAG.

In some embodiments, in the case that a timer associated with a second TAG times out, the first behavior includes at least one of:
releasing a resource associated with a current serving cell;
releasing resources associated with all serving cells;
triggering a random access procedure to recover a TA;
taking no action, and performing a corresponding behavior in the case that all TAG timers associated with a cell associated with the second TAG have timed out;
releasing a resource associated with the second TAG; or
releasing a resource associated with a second TRP.

In some embodiments of the present disclosure, the cell associated with the second TAG is one Pcell, one Pscell or one Scell. All TAG timers associated with the cell associated with the second TAG include all TAG timers associated with TRPs in the Pcell, Psell or Scell associated with the second TAG.

In some embodiments, in the case that a timer associated with a third TAG times out, the first behavior includes at least one of:
releasing a resource associated with a current serving cell;
releasing resources associated with all serving cells;
triggering a random access procedure to recover a TA;
taking no action, and performing a corresponding behavior in the case that all TAG timers associated with a cell associated with the third TAG have timed out;
releasing a resource associated with the third TAG; or
releasing a resource associated with a third TRP.

In some embodiments of the present disclosure, the cell associated with the third TAG is one Pcell one Pscell or one Scell. All TAG timers associated with the cell associated with the third TAG include all TAG timers associated with TRPs in the Pcell, Psell or Scell associated with the third TAG.

In some embodiments, in the case that a timer associated with a fourth TAG times out, the first behavior includes at least one of:
releasing a resource associated with a current serving cell;
releasing resources associated with all serving cells;
triggering a random access procedure to recover a TA;
taking no action, and performing a corresponding behavior in the case that all TAG timers associated with a cell associated with the fourth TAG have timed out;
releasing a resource associated with the fourth TAG; or
releasing a resource associated with a fourth TRP.

In some embodiments of the present disclosure, the cell associated with the fourth TAG is one Pcell one Pscell or one Scell. All TAG timers associated with the cell associated with the fourth TAG include all TAG timers associated with TRPs in the Pcell, Psell or Scell associated with the fourth TAG.

In some embodiments, in the case that the timer associated with the TAG times out, the first behavior further includes: transmitting a TA recovery request.

In some embodiments, the TA recovery request is transmitted over at least one of:
a MAC CE;
an SR; or
a random access procedure.

In some embodiments, the MAC CE carries at least one of:
a TAG identity;
a TRP identity;
a serving cell identity;
DL timing information of a TRP measured by the terminal device; or
an L1-RSRP measurement result.

In some embodiments, the resource used by the MAC CE includes at least one of: a resource dynamically scheduled by a PDCCH; a CG resource; or a resource indicated in an RAR.

In some embodiments, the SR is configured for each TRP and/or each TAG.

In some embodiments, the SR of at least one of the TAG or the TRP is associated with a PUCCH resource of the TRP; or
the SR of at least one of the TAG or the TRP is associated with a PUCCH resource of another TRP in a serving cell.

In some embodiments, the random access procedure is initiated based on a TAG with an invalid TA and a random access resource associated with at least one of the TAG or the TRP.

In some embodiments, in the case that TA associated with at least one of a first TRP, a first TAG or a third TAG is invalid, the TA is recovered by a random access procedure triggered by the terminal device.

In some embodiments, the terminal device is triggered to initiate a random access procedure to a TRP:
in the case that the terminal device initiates a contention-based random access procedure to an associated TRP based on a random access resource associated with the TRP; or
in the case that the terminal device receives indication information from the network side, wherein the indication information instructs the terminal device to initiate a non-contention-based random access resource to a target TRP.

In some embodiments, the indication information is carried over a DCI or a MAC CE.

In some embodiments, the indication information includes at least one of:
a control resource set pool index;
a TCI state;
spatial relation information;
a TAG identity;
a PCI;
a synchronization resource block (SSB) index;
a preamble index; or
a PRACH mask index.

The terminal device 700 according to the embodiments of the present disclosure can implement the corresponding functions of the terminal device in the method 600 embodiments. The processes, functions, implementation modes, and beneficial effects corresponding to various modules (submodules, units, components, or the like) within the terminal device 700 can refer to the corresponding descriptions in the above method embodiments, which are not repeated any further. It should be noted that the functions described for various modules (submodules, units, components, or the like) within the terminal device 700 according to the embodiments of the present disclosure can be implemented by different modules (submodules, units, components, or the like) or by the same module (submodule, unit, components, or the like).

FIG. 8 is a schematic structural diagram of a communication device 800 according to some embodiments of the present disclosure. The communication device 800 includes a processor 810. The processor 810 is configured to load and run one or more computer programs stored in the memory, to cause the communication device 800 to perform the methods in the embodiments of the present disclosure.

In some embodiments, the communication device 800 further includes a memory 820. The processor 810 is configured to load and run one or more computer programs stored in the memory 820, to cause the communication device 800 to perform the methods in the embodiments of the present disclosure.

The memory 820 is a separate device independent from the processor 810, or the memory 820 is integrated within the processor 810.

In some embodiments, the communication device 800 further includes a transceiver 830. The processor 810 is configured to control the transceiver 830 to communicate with other devices. For example, the processor 810 is configured to control the transceiver 830 to transmit information or data to other devices, or the processor 810 is configured to control the transceiver 830 to receive information or data from other devices.

In some embodiments, the transceiver 830 includes a transmitter and a receiver. The transceiver 830 may further include one or more antennas.

In some embodiments, the communication device 800 is the network device according to the embodiments of the present disclosure, and the communication device 800 implements the corresponding processes performed by the network device in various methods of the embodiments of the present disclosure. Details are not repeated any further for brevity.

In some embodiments, the communication device 800 is the terminal device according to the embodiments of the present disclosure, and the communication device 800 implements the corresponding processes performed by the terminal device in various methods of the embodiments of the present disclosure. Details are not repeated any further for brevity.

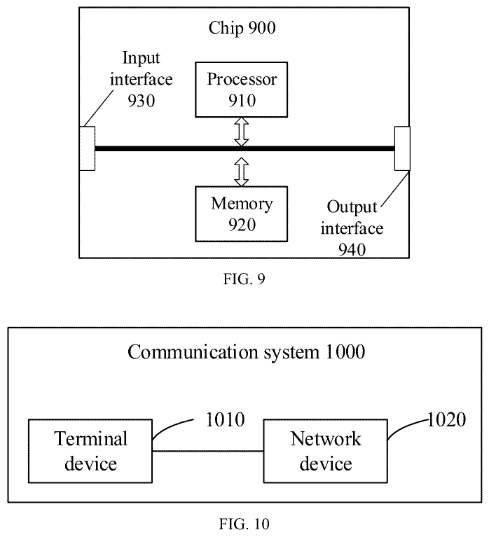

FIG. 9 is a schematic structural diagram of a chip 900 according to some embodiments of the present disclosure. The chip 900 includes a processor 910. The processor 910 is configured to load and run one or more computer programs stored in the memory, to perform the methods in the embodiments of the present disclosure.

In some embodiments, the chip 900 further includes a memory 920. The processor 910 is configured to load and run one or more computer programs stored in the memory 920, to perform the methods applicable to the terminal device or the network device in the embodiments of the present disclosure.

The memory 920 is a separate device independent from the processor 910, or the memory 920 is integrated within the processor 910.

In some embodiments, the chip 900 further includes an input interface 930. The processor 910 is configured to control the input interface 930 to communicate with other devices or chips. For example, the processor 910 is configured to control the input interface 930 to acquire information or data from other devices or chips.

In some embodiments, the chip 900 further includes an output interface 940. The processor 910 is configured to control the output interface 940 to communicate with other devices or chips. For example, the processor 910 is configured to control the output interface 940 to output information or data to other devices or chips.

In some embodiments, the chip is applicable to the network device in the embodiments of the present disclosure, and the chip implements corresponding processes performed by the network device in various methods of the embodiments of the present disclosure. Details are not repeated any further for brevity.

In some embodiments, the chip is applied to the terminal device in the embodiments of the present disclosure, and the chip implements the corresponding processes performed by the terminal device in various methods of the embodiments of the present disclosure. Details are not repeated any further for brevity.

The chips applied to the network device and the terminal device may be the same chip or different chips.

It is understandable that the chip in the embodiments of the present disclosure is also referred to as a system-level chip, a systematic chip, a chip system, or a system-on-chip.

The processor mentioned above is a general-purpose processor, a digital signal processor (DSP), a field-programmable gate array (FPGA), an application-specific integrated circuit (ASIC), or other programmable logic device, a transistor logic device, or a discrete hardware component. The general-purpose processor is a microprocessor or the processor is any conventional processor.

The memory mentioned above is a volatile memory or a non-transitory memory, or the memory includes both the transitory memory and the non-transitory memory. The non-transitory memory is a read-only memory (ROM), a programmable ROM (PROM), an erasable PROM (EPROM), an electrically EPROM (EEPROM), or a flash memory. The transitory memory is a random access memory (RAM).

It is understandable that the memory described above is exemplary but not limited. For example, the memory according to the embodiments of the present disclosure is a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), or a direct rambus RAM (DR RAM). That is, the memory in the system and method described herein is intended to include, but is not limited to, these and any other suitable types of memory.

FIG. 10 is a schematic block diagram of a communication system 1000 according to some embodiments of the present disclosure. The communication system 1000 includes a terminal device 1010 and a network device 1020.

The terminal device 1010 is configured to: determine a type of a TAG based on a first mode; and perform a first behavior based on the type of the TAG and a timer associated with the TAG.

The network device 1020 interacts with the terminal device. For example, the network device 1020 transmits indication information to the terminal device.

The terminal device 1010 is configured to implement corresponding functions implemented by the terminal device in the above methods, and the network device 1020 is configured to implement corresponding functions implemented by the network device or the network side in the above methods. Details are not repeated any further for brevity.

The embodiments described above are realized in whole or in part by software, hardware, firm ware or any combination thereof. In the case that the embodiments are performed by software, the embodiments are performed in the form of a computer program product in whole or in part. The computer program product includes one or more computer instructions. The one or more computer program instructions, when loaded and run by the computer, wholly or partially generate the flow or function according to the embodiment of the disclosure. The computer is a general purpose computer, a dedicated computer, a computer network, or other programmable device. The one or more computer instructions are stored in a computer-readable storage medium, or transmitted from one computer-readable storage medium to another computer-readable storage medium. For example, the one or more computer instructions are transmitted from a website site, a computer, a server or a data center over a cable (such as a coaxial cable, an optical fiber, a digital subscriber line (DSL)) or wireless (such as infrared, wireless, or microwave) to another website site, computer, server or data center. The computer-readable storage medium is any available medium that is accessed by a computer or a data storage device such as a server including one or more available medium integration or a data center. The available medium is a magnetic medium (for example, a floppy disk, a hard disk, and a magnetic tape), an optical medium (for example, a DVD), or a semiconductor medium (for example, a solid state disk (SSD)).

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It is understandable that, in various embodiments of the present disclosure, the serial number of each of the above processes does not imply the order of execution, and the order of execution of each of the processes should be determined by its function and inherent logic, without constituting any limitation of the implementation process of the embodiments of the present disclosure.

It is clear to those of ordinary skilled that, for the convenience and brevity of the description, the specific work processes of the systems, apparatuses, and units described above are referred to the corresponding processes in the method embodiments, and are not repeated herein.

Described above are merely specific implementations of the present disclosure, but the protection scope of the present disclosure is not limited thereto. Those skilled in the art who are familiar with the technical field would readily think of variations or substitutions within the scope of the technology disclosed in the present disclosure, which shall be covered by the protection scope of the present disclosure. Therefore, the protection scope of this application shall be subject to the protection scope of the claims.

1. A method for communication, applicable to a terminal device, the method comprising:
determining a type of a timing advance group (TAG) based on a first mode; and
performing a first behavior based on the type of the TAG and a timer associated with the TAG.

2. The method according to claim 1, wherein in a case that at least one of one cell group (CG) or one medium access control (MAC) entity is associated with one primary timing advance group (PTAG), the first mode comprises at least one of:
a TAG associated with at least one of an initially accessed cell or a transmission reception point (TRP) in at least one of a primary cell (Pcell) or a primary secondary cell (Pscell) being a first TAG;
a TAG associated with a TRP associated with control resource set 0 in at least one of a Pcell or a Pscell being a first TAG;
a TAG associated with a TRP that receives a common channel in at least one of a Pcell or a Pscell being a first TAG;
a TAG associated with a first control resource set index in at least one of a Pcell or a Pscell being a first TAG and a TAG associated with a second control resource set index being a second TAG;
a TAG associated with a TRP whose transmission configuration indicator (TCI) state is associated with beam information of a serving cell in at least one of a Pcell or a Pscell being a first TAG;
a TAG associated with a cell and/or TRP that initially initiates a random access procedure during an addition and/or change process of a secondary cell group (SCG) being a first TAG;
a TAG associated with at least one of a Pcell or a Pscell being a first TAG; or
any TAG other than the first TAG being a second TAG.

3. The method according to claim 1, wherein in a case that at least one of one cell group (CG) or one medium access control (MAC) entity is associated with two primary timing advance groups (PTAGs), the first mode comprises at least one of:
a TAG associated with at least one of a primary cell (Pcell) or a primary secondary cell (Pscell) being a first TAG; or
a TAG associated with a secondary cell (Scell) being a second TAG.

4. The method according to claim 3, wherein for one serving cell, in a case that the serving cell is the Pcell or the Pscell and the serving cell is associated with two TAGs, both TAGs are primary timing advance groups (PTAGs); and in a case that the serving cell is the Scell, each of at least one TAG associated with the cell is a secondary timing advance group (STAG).

5. The method according to claim 2, wherein an identity of the TRP comprises: an identity of a TAG.

6. The method according to claim 2, wherein in a case that a timer associated with the first TAG times out, the first behavior comprises at least one of:
releasing a resource associated with a current serving cell;
releasing resources associated with all serving cells; or
taking no action, and performing a corresponding behavior in a case that all TAG timers associated with a cell associated with the first TAG or a third TAG have timed out.

7. The method according to claim 2, wherein in a case that a timer associated with the second TAG or a fourth TAG times out, the first behavior comprises: releasing a resource associated with a current serving cell.

8. The method according to claim 1, wherein the terminal device is triggered to initiate a random access procedure to a transmission reception point (TRP):
in a case that the terminal device receives indication information from a network side, wherein the indication information instructs the terminal device to initiate a non-contention-based random access resource to a target TRP.

9. The method according to claim 8, wherein the indication information is carried over downlink control information (DCI).

10. The method according to claim 8, wherein the indication information comprises at least one of the following target TRP information:
a TAG identity;
a physical cell identifier (PCI);
a synchronization resource block (SSB) index;
a preamble index; or
a physical random access channel (PRACH) mask index.

11. A terminal device, comprising:
a processor and a memory;
wherein the memory is configured to store one or more computer programs, which when executed by the processor, cause the terminal device to:
determine a type of a timing advance group (TAG) based on a first mode; and
perform a first behavior based on the type of the TAG and a timer associated with the TAG.

12. The terminal device according to claim 11, wherein in a case that at least one of one cell group (CG) or one medium access control (MAC) entity is associated with one primary timing advance group (PTAG), the first mode comprises at least one of:
a TAG associated with at least one of an initially accessed cell or a transmission reception point (TRP) in at least one of a primary cell (Pcell) or a primary secondary cell (Pscell) being a first TAG;
a TAG associated with a TRP associated with control resource set 0 in at least one of a Pcell or a Pscell being a first TAG;
a TAG associated with a TRP that receives a common channel in at least one of a Pcell or a Pscell being a first TAG;
a TAG associated with a first control resource set index in at least one of a Pcell or a Pscell being a first TAG and a TAG associated with a second control resource set index being a second TAG;
a TAG associated with a TRP whose transmission configuration indicator (TCI) state is associated with beam information of a serving cell in at least one of a Pcell or a Pscell being a first TAG;
a TAG associated with a cell and/or TRP that initially initiates a random access procedure during an addition and/or change process of a secondary cell group (SCG) being a first TAG;
a TAG associated with at least one of a Pcell or a Pscell being a first TAG; or
any TAG other than the first TAG being a second TAG.

13. The terminal device according to claim 11, wherein in a case that at least one of one cell group (CG) or one medium access control (MAC) entity is associated with two primary timing advance groups (PTAGs), the first mode comprises at least one of:
a TAG associated with at least one of a primary cell (Pcell) or a primary secondary cell (Pscell) being a first TAG; or
a TAG associated with a secondary cell (Scell) being a second TAG.

14. The terminal device according to claim 12, wherein an identity of the TRP comprises: an identity of a TAG.

15. The terminal device according to claim 12, wherein in a case that a timer associated with the first TAG times out, the first behavior comprises at least one of:
releasing a resource associated with a current serving cell;
releasing resources associated with all serving cells; or
taking no action, and performing a corresponding behavior in a case that all TAG timers associated with a cell associated with the first TAG or a third TAG have timed out.

16. The terminal device according to claim 12, wherein in a case that a timer associated with the second TAG or a fourth TAG times out, the first behavior comprises: releasing a resource associated with a current serving cell.

17. The terminal device according to claim 11, wherein the terminal device is triggered to initiate a random access procedure to a transmission reception point (TRP):
in a case that the terminal device receives indication information from a network side, wherein the indication information instructs the terminal device to initiate a non-contention-based random access resource to a target TRP.

18. The terminal device according to claim 17, wherein the indication information is carried over downlink control information (DCI).

19. The terminal device according to claim 17, wherein the indication information comprises at least one of the following target TRP information:
a TAG identity;
a physical cell identifier (PCI);
a synchronization resource block (SSB) index;
a preamble index; or
a physical random access channel (PRACH) mask index.

20. A chip, comprising:
a processor;
wherein the processor is configured to execute one or more computer programs from a memory to cause a device equipped with the chip to:
determine a type of a timing advance group (TAG) based on a first mode; and
perform a first behavior based on the type of the TAG and a timer associated with the TAG.
